(19) United States
(12) Patent Application Publication
(10) Pub. No.: US 2008/0248740 A1
(43) Pub. Date: Oct. 9, 2008

(54) Method and System for Sharing Content Items and their Metadata Among Mobile Device Users and Purchasing Content Items From an Online Store

(75) Inventors: Alexander Lazovsky, Petah Tikva (IL); Jhanna Lazovsky, Petah Tikva (IL); Alexander Zaidelson, Rehovot (IL); Camuel Gilyadov, Petach Tikvah (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: NETBARRAGE LTD, Petach Tikvah (IL)

(21) Appl. No.: 12/090,858

(22) PCT Filed: Oct. 19, 2006
(86) PCT No.: PCT/IL06/01204

§ 371 Date: May 2, 2008

Related U.S. Application Data
(60) Provisional application No. 60/596,761, filed on Oct. 19, 2005.
(60) Provisional application No. 60/596,800, filed on Oct. 21, 2005.

(51) Int. Cl. H04H 20/71

(52) U.S. Cl. 455/3.01

(57) ABSTRACT

The present invention relates to a method and system for short-range sharing data among mobile device users and for purchasing one or more content items represented by or relating to the shared data, comprising: (a) providing a plurality of mobile devices, each having one or more short-range communication capabilities, for communicating and sharing said data with other such mobile devices by means of a software component installed within each of said mobile devices, wherein when the shared data includes a content item, the content item is prevented from being played until it is purchased from an online store; and (b) providing an online store over a data network, enabling each user of said mobile devices to access said online store, and to purchase said content item included within said shared data.

### FIELD OF THE INVENTION

The present invention relates to peer-to-peer data sharing. More particularly, the invention relates to a method and system for sharing data, such as video or audio content items (files), content items metadata, etc., among mobile device users and then purchasing one or more corresponding content items from an online store over a data network, such as the Internet.

### BACKGROUND OF THE INVENTION

Throughout this specification, the following definitions are employed:

Bluetooth: is an industrial specification for an RF (Radio Frequency) wireless personal area networks. Bluetooth provides a way to connect and exchange information between devices like personal digital assistants (PDAs), mobile phones, laptops, personal computers (PCs), printers and digital cameras via a secure, low-cost, globally available short range radio frequency. Bluetooth lets these devices talk to each other when they come in range, even if they are not in the same room, as long as they are within up to about 100 meters of each other, dependent on the power class of the product.

Peer-To-Peer Network (or P2P): is a computer network in which each workstation has equivalent capabilities and responsibilities. This differs from client/server conventional networks, in which some computers are dedicated to serving the others. Peer-to-peer networks are generally simpler, but they usually do not offer the same performance under heavy loads. P2P computer network relies on the computational power and bandwidth of the participants in the network rather than on a relatively low number of servers, as conventional networks do. P2P networks are useful for many purposes, such as sharing content files containing audio, video and any other types of data in a digital format.

Wi-Fi: is a short form for a wireless fidelity. This term is developed to describe wireless local area network (WLAN) products and a family of protocols, which are based on the Institute of Electrical and Electronics Engineers' (IEEE) standards.

Conventional mobile devices, such as cellular phones, Portable Music Players, PDAs (Personal Digital Assistants), etc. may have short-range communication capabilities, e.g. Bluetooth, Wi-Fi, Infrared, ZigBee, etc. enabling their users to exchange data among themselves. Users with such communication capabilities can connect their mobile devices one to another and download/upload various data.

However, the prior art does not enable a mobile device user (having short-range communication capabilities) to search on mobile devices of other users for a specific file or for specific metadata, such as a song/movie title, author, genre, etc., similarly to conventional computer peer-to-peer data networks, such as BitTorrent, ED2K, FastTrack, Gnutella, Overnet, etc. Each of the conventional computer peer-to-peer networks has corresponding peer-to-peer file-sharing software that uses it. For example, FastTrack is used by Kazaa™ and Kazaa Lite™ software, ED2K is used by eMule and eDonkey™ software, etc. Each peer-to-peer user can search for a specific file shared by one or more other users over the corresponding peer-to-peer network. When finding the required file, the user downloads it by means of dedicated software installed on his computer. However, conventional peer-to-peer computer networks are not designed to be used on mobile devices (e.g., cellular phones, PDAs, Portable Music Players, etc.), and thus mobile device users cannot perform peer-to-peer data sharing between their mobile devices as it can be done between computers.

Furthermore, the prior art does not enable a mobile device user to legally purchase a content item (such as a song, movie, image, etc.) that was downloaded fully or in part from another mobile device.

It is an object of the present invention to enable mobile device users to legally share content items stored on their mobile devices, such as audio/video files, file metadata (e.g. song/movie title, author, genre, singer, etc.) by means of the conventional short-range data communication, such as Bluetooth, Wi-Fi, Infrared, etc.

It is another object of the present invention to enable a mobile device user to make a search on other users' mobile devices, which are within a communication range from said device, for one or more particular content items (songs, movies, etc.) by using one or more corresponding keywords.

It is still another object of the present invention to provide a method and system for enabling mobile device users to recommend to other users one or more particular content items by sending metadata of each of said items (e.g., title, singer, actor, etc.), and/or preview of said items (e.g., short movie scene, a portion of a song, etc) to mobile devices of said other users.

It is a further object of the present invention to provide a method and system for enabling mobile device users to purchase legitimate data contents upon receiving metadata and/or preview of said data contents from other mobile device users.

It is still a further object of the present invention to provide a method and system for enabling mobile device users to download desired content items (songs, movies, etc.) from other users, wherein the downloaded items are prevented from being played until they are legally purchased from an online store over a data network, such as the Internet.

Other objects and advantages of the invention will become apparent as the description proceeds.

### SUMMARY OF THE INVENTION

The present invention relates a method and system for sharing data, such as video or audio content items (files), content items metadata, etc., among mobile device users and then purchasing one or more corresponding content items from an online store over a data network, such as the Internet.

The system for short-range sharing data among mobile device users and for purchasing one or more content items represented by or relating to the shared data comprises: (a) a plurality of mobile devices, each having one or more short-range communication capabilities, for communicating and sharing said data with other such mobile devices by means of a software component installed within each of said mobile devices, wherein when the shared data includes a content item, the content item is prevented from being played until it is purchased from an online store; and (b) an online store over a data network, enabling each user of said mobile devices to access said online store, and to purchase said content item included within said shared data.

Preferably, purchasing of the one or more content items is performed by connecting said each mobile device to a computer, that is connected to the data network, and accessing said online store by means of said computer.

Preferably, the shared data is one or more of the following: (a) one or more content items; (b) one or more portions of said one or more content items; (c) metadata of said one or more content items; and (d) rating of each of said one or more content items.

Preferably, the online store is provided with a software component that automatically identifies the content item stored within user's mobile device or a portion of which is stored within said device, and provides the user with a corresponding price for purchasing said content item from the online store.

Preferably, the content item is identified by using one or more conventional content recognition techniques.

Preferably, the content item is identified by means of fingerprinting.

Preferably, if the content item is not identified by the software component, then the content item is unlocked, and the user is able to play it.

Preferably, a portion of each content item can be played on user's mobile device without being purchased from the online store.

Preferably, a user further recommends to another user to purchase one or more content items by sending him metadata of said one or more content items, portions of said one or more content items or additional data relating to said one or more content items.

Preferably, the metadata of the content item further comprises a unique identifier of a user from whose mobile device said metadata and/or the corresponding content items are downloaded, said identifier embedded in said metadata and retrieved by a mobile device of the user that receives the recommendation.

Preferably, the metadata of the content item further comprises a unique identifier of a user who recommends purchasing said item, said identifier embedded in said metadata and retrieved by a mobile device of the user that receives the recommendation.

Preferably, the mobile device user who recommends purchasing the content item to another user is further credited when the recommended item is purchased by said another user.

Preferably, the mobile device user from whose mobile device the content item and/or its metadata are downloaded, is further credited when the downloaded item is purchased by said another user.

Preferably, the user further searches on other users' mobile devices by means of the software component installed on his mobile device for one or more content items or for metadata of said one or more content items, by using one or more corresponding keywords.

The method for short-range sharing data among mobile device users and for purchasing one or more content items represented by or relating to the shared data comprises: (a) providing a plurality of mobile devices, each having one or more short-range communication capabilities, for communicating and sharing said data with other such mobile devices by means of a software component installed within each of said mobile devices, wherein when the shared data includes a content item, the content item is prevented from being played until it is purchased from an online store; and (b) providing an online store over a data network, enabling each user of said mobile devices to access said online store, and to purchase said content item included within said shared data.

### BRIEF DESCRIPTION OF THE DRAWINGS

In the drawings:

FIG. 1A is a schematic illustration of a system for sharing data among mobile device users, and for legal purchasing of the shared data, according to an embodiment of the present invention;

FIG. 1B is a schematic illustration of a system for searching for a specific content item, such as a song called “Stronger” of Britney Spears, according to an embodiment of the present invention;

FIG. 1C is a schematic illustration of a system for recommending a specific content item by a mobile device user to other one or more users (located within a communication range), according to an embodiment of the present invention;

FIG. 2A is a schematic illustration of a system for purchasing a content item that was downloaded from one mobile device to another, or for purchasing a content item according to its metadata received from said another mobile device, according to an embodiment of the present invention; and

FIG. 2B is a schematic illustration of a system for sharing data among mobile device users, and for legal purchasing of the shared data, according to another embodiment of the present invention.

### DETAILED DESCRIPTION OF THE PREFERRED EMBODIMENTS

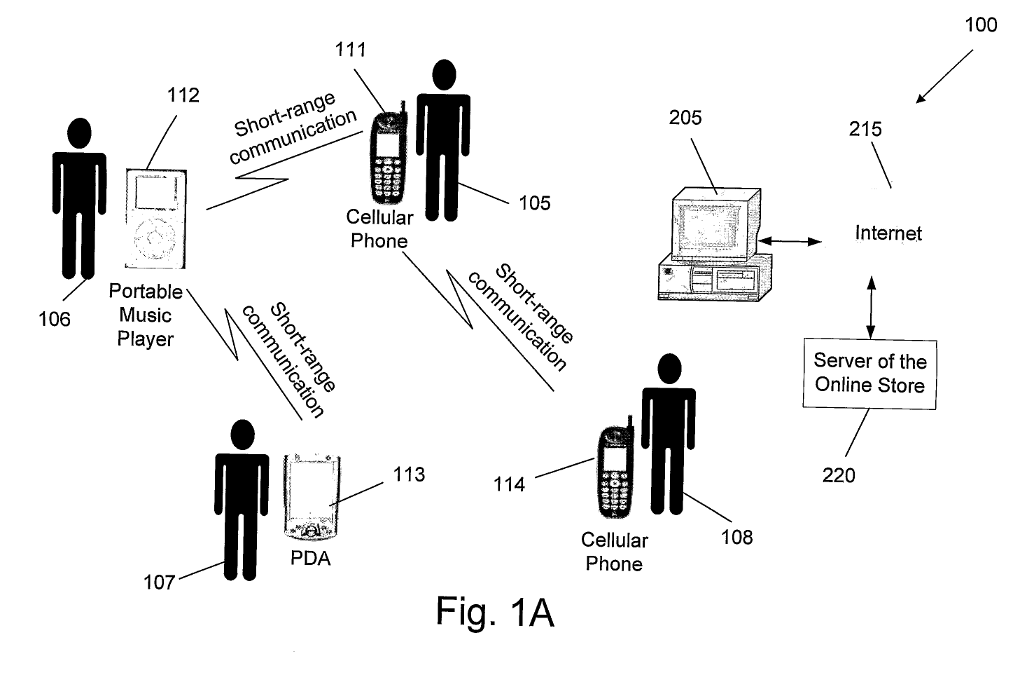

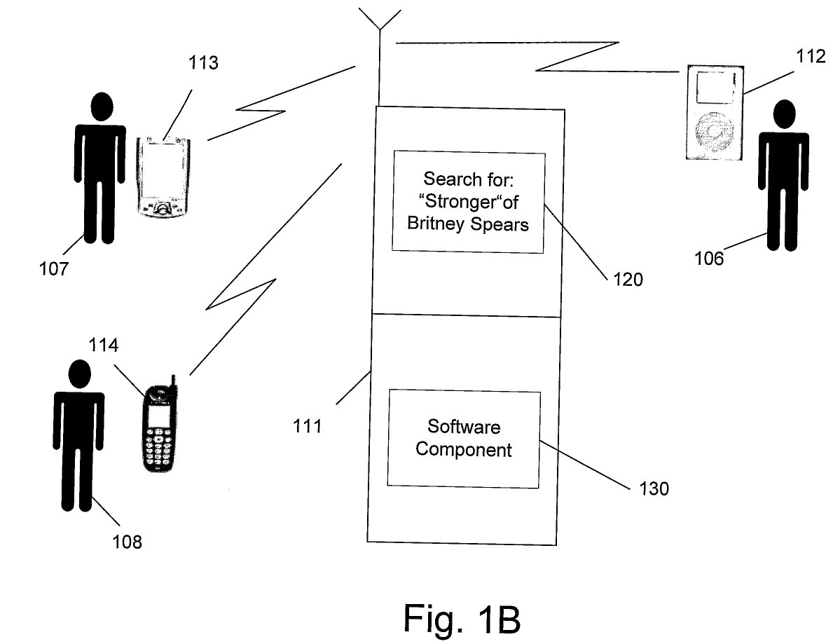

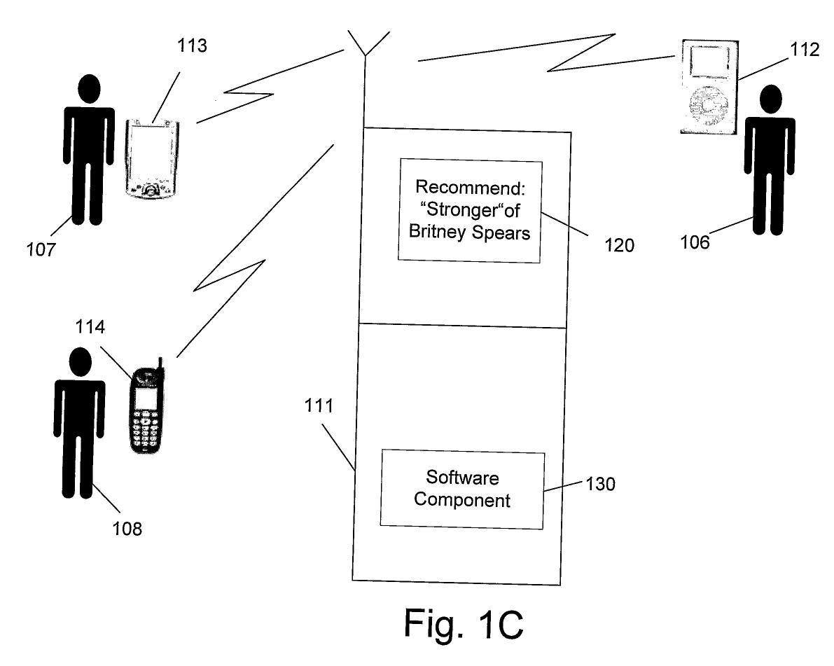

FIG. 1A is a schematic illustration of a system 100 for sharing data among mobile device users, and for legal purchasing of the shared data, according to an embodiment of the present invention. System 100 comprises a plurality of mobile devices, each having short-range communication capability, such as Bluetooth, Wi-Fi, Infrared, ZigBee, etc. for communicating with one another, and each mobile device provided with a software component for peer-to-peer sharing of one or more content items (files) stored within each of said devices and for peer-to-peer sharing of metadata and/or preview of one or more content items; and a conventional PC (Personal Computer) 205 connected to a data network, such as Internet 215 enabling mobile device users to connect to an online content store (provided within server 220) and to acquire (purchase) corresponding one or more content items (files). The mobile devices can be cellular phones 111 and 114, Portable Music Player 112, PDA 113, etc. Each device can send or receive data from another device that is located within its communication range that can be, for example, up to 100 meters.

According to an embodiment of the present invention, mobile device users can share data while traveling in train, bus, and the like, or while in a pub, bar, class, party, or any other public place. The data shared by mobile device users can be one or more of the following or a combination thereof: a data file, such as a multimedia, music, image or video file; metadata, such as a song/movie title, singer, movie actor, etc.; a preview of a content item, e.g., a portion of a song or a movie clip. Each user, when in a public place, can search for all compatible mobile devices within his mobile device communication range, and then he can connect to each detected mobile device and can obtain a searchable list of all files (songs, movies, images, etc.) shared by said each mobile device. In addition, each content item in the list (or metadata of said each item) can be rated by other users who share said item. Thus, the user before downloading the item, has an indication whether other users liked the item or not.

After that, the user can download one or more files or portions of said files. For that, a software component is installed on each mobile device, enabling each user to determine a list of files shared by other users and enabling him to download these files.

According to an embodiment of the present invention, a mobile device user, such as user 105, 106, 107 or 108 can search for a specific file (song, movie, etc.) or metadata (e.g. titles of Britney Spears songs) on other user's mobile devices, which are located within a communication range by providing one or more corresponding keywords. For example, if user 105 wishes to download Britney Spears song called “Stronger”, he types the song title (“Stronger”) by means of his mobile device keypad and, optionally, he also types a name of the singer (Britney Spears), and searches for this song within other user's mobile devices by means of a software component installed on his mobile device. As a result, the user receives a list of all mobile devices (that are within the communication range) that share said song. Then, the user selects a device from the list, from which he wishes to download the song, and after that, downloads it.

It should be noted that according to another embodiment of the present invention, a mobile device user makes a search on other user's mobile devices by general search keywords, such as a name of an artist (e.g. “Britney Spears”), or a genre (“Hip-Hop”). As a result, he receives a list of all Britney Spears or Hip-Hop content items shared by said devices.

According to an embodiment of the present invention, files downloaded by each mobile device user are prevented from being played (or they are played only partially) on his mobile device until he (legally) purchases them. To do so, each user, after downloading the desirable file or a portion of a file from another mobile device, connects his or her mobile device to a data network, such as Internet 215 by means of conventional PC 205. Then, the user accesses (connects to) an online content store, wherein he can purchase the file by means of a software component installed on his PC and/or on his mobile device. The software component can automatically access user's online account (if the user has an account; otherwise the user is requested to create a new account), check availability and pricing of the downloaded content items, and acquire one or more content items upon receiving user's confirmation. After the file is acquired, it can be downloaded to user's mobile device and/or to PC 205 from said online store provided within server 220.

When a mobile device (such as cellular phone 114) accesses (connects to) the online store (e.g. by means of PC 205 or directly, by using a data network connection that can be provided within said device), each content item (or a portion thereof) that was previously downloaded from another mobile device (e.g. from device 111, 112 or 113), can be automatically identified by means of a software component installed within server 220 of said online store and/or a software component of said online store that runs on PC 205. This is done by analyzing contents of the file representing said content item using conventional content recognition methods, such as fingerprinting (e.g., Robust Audio Hashing or similar), and/or by analyzing the file metadata, if said metadata was downloaded from said another mobile device. After the file is successfully recognized by server 220, either by analyzing the metadata or by using the fingerprinting technique, the user can purchase the file. When the user acquires the file, he can be provided with an unlocking (decryption) key enabling him to play the content item (file) that he already downloaded from another mobile device. Optionally, the user can download the already unlocked (decrypted) file from the online store. If the user has only a portion of the file (content item), he downloads the full file from said online store (after purchasing said content item). If the user decides not to purchase the content item, then the file (or a portion thereof) can be automatically removed from his mobile device.

It should be noted that if the content item is not identified by the software component, then the content item can be unlocked, and the user is able to play it. Also, it should be noted that a portion of each content item can be played on user's mobile device without a need to be purchased from the online store.

According to another embodiment of the present invention, the user downloads metadata of one or more content items from other mobile device users. For example, the user can download titles of hit parade top 10 songs, or names of popular movie actors along with the titles of corresponding movies in which they are acting, etc. Then, the user can access (connect to) the online store by means of PC 205 connected to a data network, such as Internet 215 (or directly, by using a data network connection that can be provided within user's mobile device) and purchase (acquire) one or more corresponding content items relating to the downloaded metadata.

According to an embodiment of the present invention, each user can recommend to one or more other users to acquire a specific file (song, movie, etc.) by sending them corresponding metadata of said file. The metadata can be sent either in a binary or in a text format. Also, the metadata can be automatically or manually encrypted before transmitting it from one device to another, and decrypted upon receiving it at said another device by means of a predefined decryption key. The metadata received by a user can further comprise a unique identifier of the recommending mobile device user. This identifier can be embedded in said metadata and retrieved by a device that receives the recommendation. Thus, when a user acquires one or more content items relating to the recommended metadata, he can get special discounts by providing (automatically or manually) said unique identifier to the online store. Then, the corresponding user, who recommended acquiring said content items, can be credited accordingly (e.g., he can be credited by receiving a predefined sum of money or by receiving special offers and discounts).

According to another embodiment of the present invention, each content item downloaded from a mobile device user, comprises a unique identifier of said user. Then, when one or more users, who downloaded said items, purchase them at the online store, the user is credited accordingly (e.g., he can be credited by receiving a predefined sum of money or by receiving special offers and discounts).

FIG. 1B is a schematic illustration of a system for searching for a specific content item, such as a song called “Stronger” of Britney Spears, according to an embodiment of the present invention. A user, wishing to download a specific content item, activates corresponding software component 130, installed within his mobile device 111 and types one or more corresponding keywords, such as the song title (“Stronger”) by means of his mobile device keypad. According to another embodiment of the present invention, he further types a name of the singer (Britney Spears), and searches for this song within other user's mobile devices by means of said software component 130. As a result, the user receives a list of all mobile devices (within the communication range) that share said song (the list is displayed on his mobile device screen 120). Then, the user selects a device from said list, from which he wishes to download the song, and after that, he downloads it.

It should be noted that the user can also search for metadata of one or more content items within other user's mobile devices, such as a title of the content item, a name of a singer or actor, etc. For example, the user can search for a list of songs that are within Britney Spears new audio album; titles of new action movies that are currently screened in the cinema; his favorite genre music; new audiobooks, etc.

FIG. 1C is a schematic illustration of a system for recommending a specific content item by a mobile device user to other one or more users (located within a communication range), according to an embodiment of the present invention. The recommended content item can be a song, movie, image, picture, painting, etc. For recommending a specific content item to other users, a mobile device user activates a corresponding software component 130 installed on his mobile device, and inserts metadata of a content item: for example, types the song title (e.g., “Stronger”) by means of his mobile device keypad, or selects one or more content items from a list of content items stored on his mobile device. According to another embodiment of the present invention, he further types a name of a singer, for example, Britney Spears. Then, the user sends this metadata and/or a preview of the corresponding content items to one or more users within the communication range. If he wishes to send his recommendation to a specific user, he selects the mobile device of said user from a list of all mobile devices detected by means of said software component 130, and sends the recommendation only to said specific user.

According to an embodiment of the present invention, the metadata received by a mobile device user can further comprise a unique identifier of another user who sent the recommendation, or from whom the file and/or metadata were downloaded/received. This identifier can be embedded into said metadata and retrieved by a device that receives the recommendation. Thus, when a user acquires one or more content items relating to the recommended metadata, he can get special discounts by providing (automatically or manually) said unique identifier to the online store. Then, the corresponding user, who recommended acquiring said content items, can be credited accordingly.

According to an embodiment of the present invention, the user who receives a recommendation (metadata of a content item) from another user or downloads one or more content items from him, can reveal said another user. For that, a mobile device of the first user (who receives the recommendation or downloads one or more content items) automatically sends a signal to a mobile device of said another user, instructing it to make a visual or audio signal, such as a light signal, a beep sound, a vibration signal, and the like.

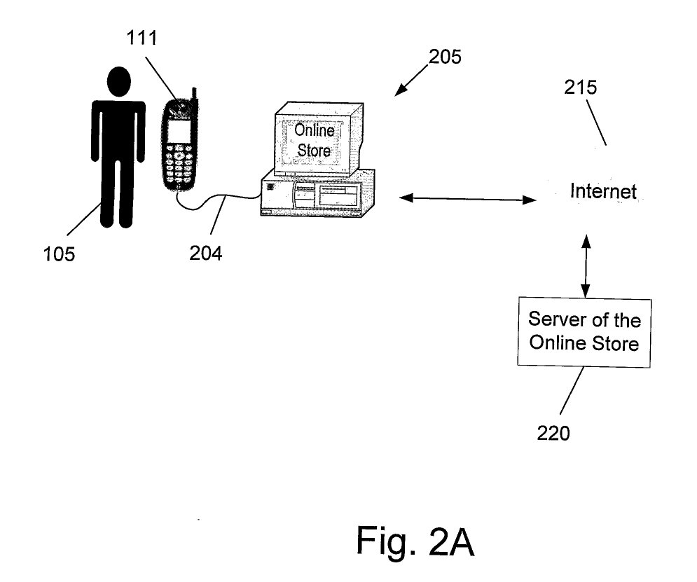

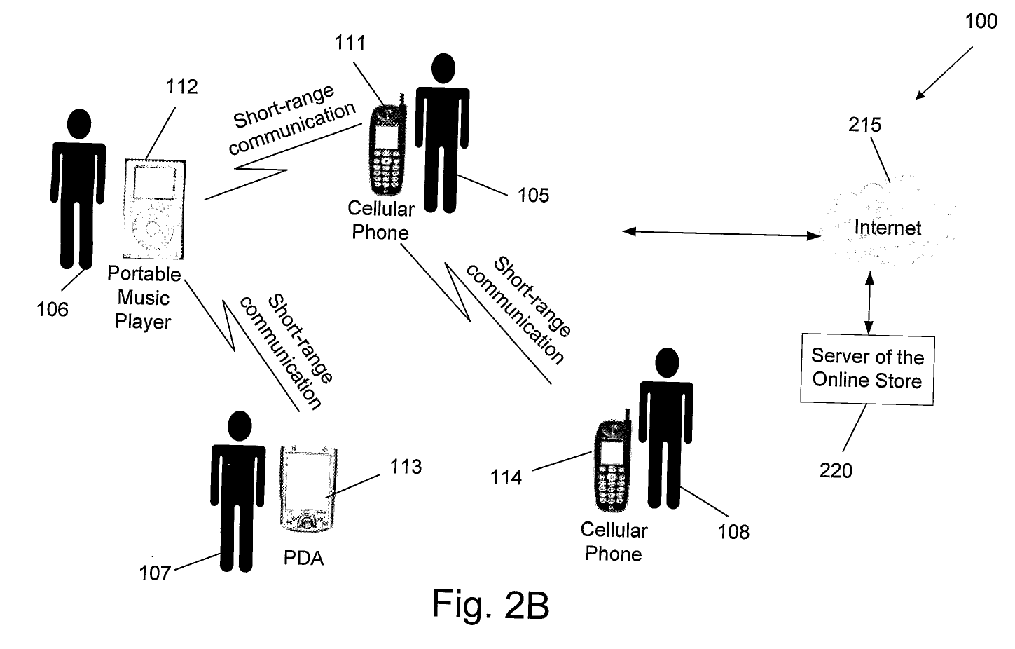

FIG. 2A is a schematic illustration of a system for purchasing a content item that was downloaded from one mobile device to another, or for purchasing a content item according to its metadata received from said another mobile device, according to an embodiment of the present invention. After a mobile device user downloads a desired content item, such as a song or a portion of a song from another mobile device, he cannot play the downloaded content item until he purchased it from the online store provided within sever 220 over a data network, such as Internet 215. For that, user 105 connects his mobile device (by means of a cable 204 or wirelessly) to conventional PC 205 that is connected to said data network. According to another embodiment of the present invention, user's mobile device has an Internet connection and is connected to said data network. Then, by means of a software component installed within said PC and/or within user's mobile device, the user can automatically access his online account (or create an account if he does not have one), check availability and pricing of a desirable content item, and purchase it if he wishes so. After the content item is purchased, the corresponding file(s) representing the item can be downloaded to user's mobile device and/or to PC 205.

When mobile device 111 is connected to the online store, each content item (or a portion of a content item) that was previously downloaded from another mobile device, can be automatically identified by means of a software component installed within server 220 of said online store, and/or a software component of said online store that runs on PC 205 by analyzing contents of the file representing said content item and/or by analyzing the file metadata, if said metadata was downloaded from said another mobile device. The identification can be done by using conventional content recognition methods (techniques), such as fingerprinting (e.g., Robust Audio Hashing or similar). After the file is successfully recognized by server 220, either by analyzing the metadata or by using the fingerprinting technique, the user can purchase it. When the user purchases the content item, he can be provided with an unlocking (decryption) key enabling him to play the content item (file) that he already downloaded from another mobile device. According to another embodiment of the present invention, the user can download the already unlocked (decrypted) file from the online store. If the user has only a portion of the file, he downloads the full file from said online store (after acquiring it). If the user decides not to acquire the file, then said file (or a portion of it) can be automatically removed from his mobile device.

FIG. 2B is a schematic illustration of a system 100 for sharing data among mobile device users, and for legal purchasing of the shared data, according to another embodiment of the present invention. According to this embodiment, user's mobile device is connected to a data network, such as Internet 215 and therefore, he can connect to server 220 of the online store directly from his mobile device without using PC 205 (FIG. 1A).

Thus, the user can purchase one or more content items, downloaded to his mobile device from other users, by connecting to the online store. Similarly, the user can purchase or more content items, whose metadata was recommended by one or more other mobile device users, or whose preview and/or rating were received from said other users.

It should be noted that according to an embodiment of the present invention, each content item (or a portion of a content item) that was previously downloaded from another mobile device, can be automatically identified by means of a software component installed within server 220 of the online store, and/or a software component of said online store that runs on user's mobile device (or PC 205, as shown on FIG. 1A) that is connected to said online store. It should be noted that the data network connection can be permanent or intermittent. For example, if a mobile device has a Wi-Fi connection capability, then the Internet connection is available only in areas with Wi-Fi conventional hotspots (Wi-Fi access points).

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. System for short-range sharing data: among mobile device users and for purchasing one or more content items represented by or relating to the shared data, comprising:
a. a plurality of mobile devices, each having one or more short-range communication capabilities, for communicating and sharing said data with other such mobile devices by means of a software component installed within each of said mobile devices, wherein when the shared data includes a content item, the content item is prevented from being played until it is purchased from an online store; and
b. an online store over a data network, enabling each user of said mobile devices to access said online store, and to purchase said content item included within said shared data.

2. System according to claim 1, wherein purchasing of the one or more content items from the online store is performed by connecting said each mobile device to a computer, that is connected to the data network, and accessing said online store by means of said computer.

3. System according to claim 1, wherein the shared data is one or more of the following:
a. one or more content items;
b. one or more portions of said one or more content items;
c. metadata of said one or more content items; and
d. rating of each of said one or more content items.

4. System according to claim 3, wherein the online store is provided with a software component that automatically identifies the content item stored within user's mobile device or a portion of which is stored within said device, and provides the user with a corresponding price for purchasing said content item from said online store.

5. System according to claim 4, wherein the content item is identified by using one or more conventional content recognition techniques.

6. System according to claim 5, wherein the content item is identified by means of fingerprinting.

7. System according to claim 4, wherein if the content item is not identified by the software component, then the content item is unlocked, and the user is able to play it.

8. System according to claim 3, wherein a portion of each content item is able to be played on user's mobile device without being purchased from the online store.

9. System according to claim 3, wherein a user further recommends to another user to purchase one or more content items by sending him metadata of said one or more content items, portions of said one or more content items or additional data relating to said one or more content items.

10. System according to claim 3, wherein the metadata of the content item further comprises a unique identifier of a user from whose mobile device said metadata and/or the corresponding content items are downloaded, said identifier embedded in said metadata and retrieved by a mobile device of the user that receives the recommendation.

11. System according to claim 9, wherein the metadata of the content item further comprises a unique identifier of a user who recommends purchasing said item, said identifier embedded in said metadata and retrieved by a mobile device of the user that receives the recommendation.

12. System according to claim 9, wherein the mobile device user who recommends purchasing the content item to another user is further credited when the recommended item is purchased by said another user.

13. System according to claim 3, wherein the mobile device user from whose mobile device the content item and/or its metadata are downloaded, is further credited when the downloaded item is purchased by said another user.

14. System according to claim 3, wherein the user further searches on other users, mobile devices by means of the software component installed on his mobile device for one or more content items or for metadata of said one or more content items, by using one or more corresponding keywords.

15. Method for short-range sharing data among mobile device users and for purchasing one or more content items represented by or relating to the shared data, comprising:
a. providing a plurality of mobile devices, each having one or more short-range communication capabilities, for communicating and sharing said data with other such mobile devices by means of a software component installed within each of said mobile devices, wherein when the shared data includes a content item, the content item is prevented from being played until it is purchased from an online store; and
b, providing an online store over a data network, enabling each user of said mobile devices to access said online store, and to purchase said content item included within said shared data.

16. Method according to claim 15, further comprising purchasing the one or more content items from the online store by connecting each mobile device to a computer connected to the data network, and accessing said online store by means of said computer.

17. Method according to claim 15, further comprising providing the shared data as one or more of the following:
a. one or more content items;
b. one or more portions of said one or more content items;
c. metadata of said one or more content items; and
d. rating of each of said one or more content items.

18. Method according to claim 17, further comprising providing the online store with a software component that automatically identifies the content item stored within user's mobile device or a portion of which is stored within said device, and provides the user with a corresponding price for purchasing said content item from said online store.

19. Method according to claim 18, further comprising identifying the content item by using one or more conventional content recognition techniques.

20. Method according to claim 19, further comprising identifying the content item by means of fingerprinting.

21. Method according to claim 17, further comprising recommending by one user to another to purchase one or more content items by sending him metadata of said one or more content items, portions of said one or more content items or additional data relating to said one or more content items.

22. Method according to claim 17, further comprising providing within the metadata of the content item a unique identifier of a user from whose mobile device said metadata and/or the corresponding content item are downloaded, said identifier embedded in said metadata and retrieved by a mobile device of the user that receives the recommendation.

23. Method according to claim 21, further comprising providing within the metadata of the content item a unique identifier of a user who recommends purchasing said item, said identifier embedded in said metadata and retrieved by a mobile device of the user that receives the recommendation.

24. Method according to claim 17, further comprising crediting the mobile device user from whose mobile device said item and/or its metadata are downloaded by another user, said mobile device user credited when the downloaded item is purchased by said another user.

25. Method according to claim 21, further comprising crediting the mobile device user who recommends purchasing the content item to another user, said mobile device user credited when the recommended item is purchased by said another user.

26. Method according to claim 17, further comprising searching on users' mobile devices for one or more content items or for metadata of said one or more content items, by using one or more corresponding keywords.
